(19) United States
(12) Patent Application Publication
(10) Pub. No.: US 2005/0078211 A1
(43) Pub. Date: Apr. 14, 2005

(54) Handheld device with integral axial camera

(76) Inventors: Symon Whitehorn, San Francisco, CA (US); Maaike L. Evers, San Francisco, CA (US); Brett Lovelady, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/632,616

(22) Filed: Jul. 31, 2003

(51) Int. Cl. H04N 5/225; H04N 5/222; H04N 9/04

(52) U.S. Cl. 348/376; 348/373; 348/333.06; 348/333.01; 348/207.99

(57) ABSTRACT

A handheld device with integral axial camera is disclosed. The apparatus discloses: a top portion; a bottom portion; a hinge, rotational about a first axis and having a first end and a second end, coupling the top portion to the bottom portion; and an image capture device, coupled to the first end of the hinge and oriented to capture images aligned along the first axis of the hinge. The method discloses: permitting a first large screen interface to rotate about a first hinge axis with respect to a second large screen interface; capturing images aligned along the first hinge axis; and setting a mode in which the device operates in response to an orientation of the first large screen interface to a second large screen interface.

### BACKGROUND OF THE INVENTION

1. Field of the Invention

The present invention relates generally to handheld devices, and more particularly toward incorporating a camera into a handheld device.

2. Discussion of Background Art

Handheld devices, such as Personal Digital Assistants (PDAs), are information appliances geared toward mobile users. They have been evolving very quickly as users are demanding, and manufacturers are adding, new features and functionalities at an increasing pace.

Basic handheld devices are commonly used for maintaining personal information, such as schedules, lists of names and phone numbers, performing basic calculations, and note taking. However some enhanced handheld devices may further include: a cell phone, modem, a wireless connection, e-mail, and Web browsing capabilities. Most have tiny keyboards, while others include touch pads.

Many of the enhanced handheld features, however, have been hastily added, and thus tend to be unrefined, bulky, and difficult to use. For example, recent handhelds have included a still camera as a next “must have” feature. These cameras tend to be tacked wherever there is space left, but often are very awkward to use and/or have limited capabilities.

In response to the concerns discussed above, what is needed is handheld computer that overcomes the problems of the prior art.

### SUMMARY OF THE INVENTION

The present invention is a handheld device with integral axial camera. The apparatus of the present invention includes: a top portion; a bottom portion; a hinge, rotational about a first axis and having a first end and a second end, coupling the top portion to the bottom portion; and an image capture device, coupled to the first end of the hinge and oriented to capture images aligned along the first axis of the hinge.

The method of the present invention includes: permitting a first large screen interface to rotate about a first hinge axis with respect to a second large screen interface; capturing images aligned along the first hinge axis; and setting a mode in which the device operates in response to an orientation of the first large screen interface to a second large screen interface.

These and other aspects of the invention will be recognized by those skilled in the art upon review of the detailed description, drawings, and claims set forth below.

### BRIEF DESCRIPTION OF THE DRAWINGS

FIG. 1 is a first pictorial diagram of one embodiment of a handheld device;

FIG. 2 is a second pictorial diagram of the one embodiment;

FIG. 3 is a third pictorial diagram of the one embodiment;

FIG. 4 is a fourth pictorial diagram the one embodiment;

FIG. 5 is a fifth pictorial diagram the one embodiment; and

FIG. 6 is a flowchart of one embodiment of a method of operation for the device.

### DETAILED DESCRIPTION OF THE PREFERRED EMBODIMENT

The present invention ergonomically incorporates an image capture device into a hand held device. By placing image capture and display devices axially within the handheld device's hinge, the present invention permits users to capture and view images under any lighting condition, while holding the device in a natural and ergonomically friendly manner, and even when the device is in a folded orientation. Such an axial location also permits a variety of aftermarket lenses and filters to be attached to the image capture device for better viewing. Also the relatively long length of the hinge permits optical lenses to translate along the axis for telephoto or wide angle image captures.

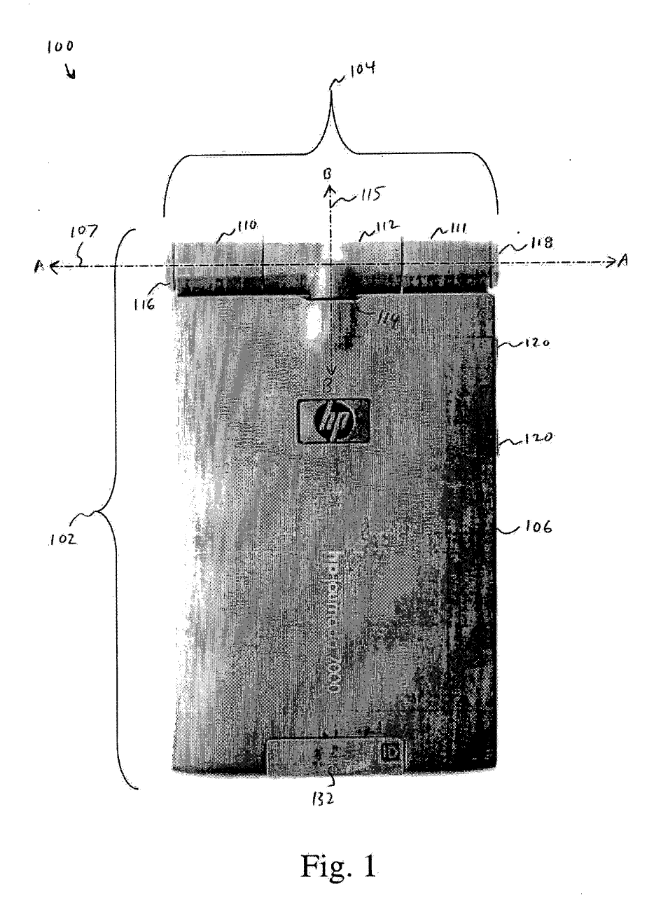

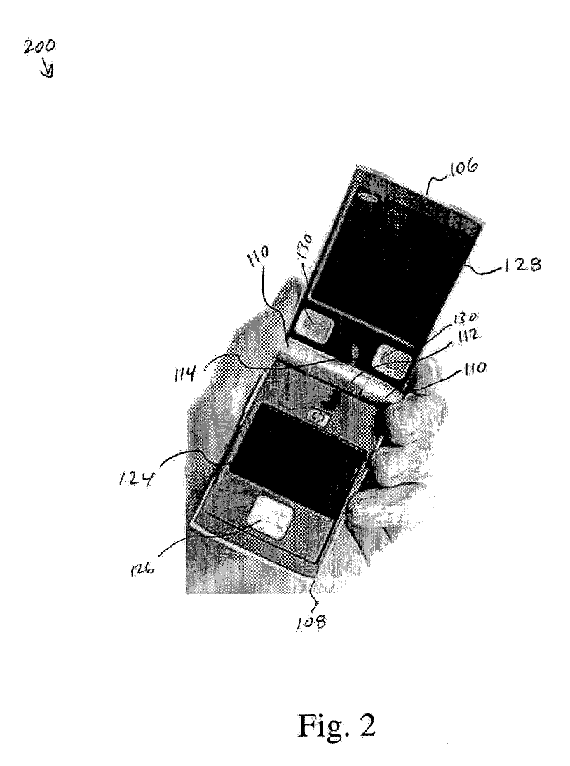

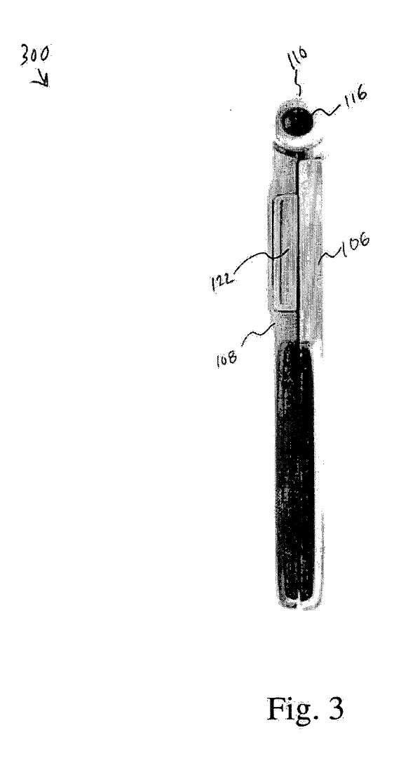

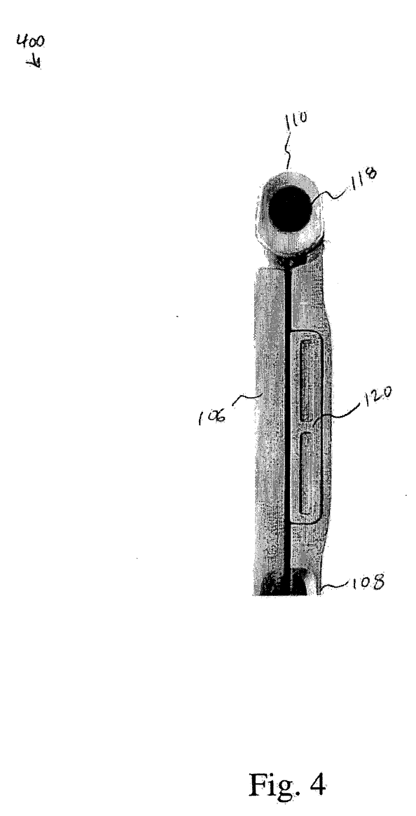

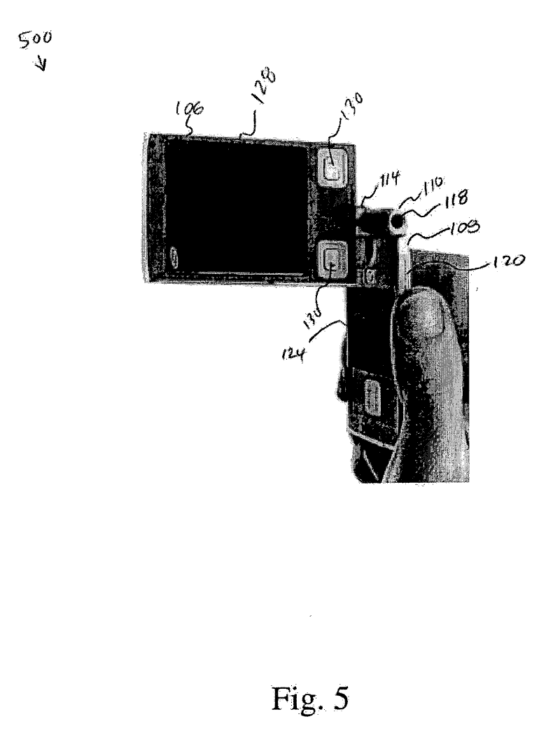

FIG. 1 is a first pictorial diagram 100 of one embodiment of a handheld device 102. FIG. 2 is a second pictorial diagram 200 of the one embodiment. FIG. 3 is a third pictorial diagram 300 of the one embodiment. FIG. 4 is a fourth pictorial diagram 400 the one embodiment. And, FIG. 5 is a fifth pictorial diagram 500 the one embodiment. FIGS. 1 through 5 are discussed together.

The handheld device 102 preferably falls into a class of devices known as Personal Digital Assistants (PDAs), and thus preferably provides certain computing and information storage and retrieval functionalities common to the class. Alternative embodiments of the present invention, however, could be embodied within other types of hinged apparatus, such as cell phones, a laptop computers, notepads, or even items of luggage.

The device 102 includes a hinge 104 which permits a top cover 106 to rotate about a first axis (A) 107 with respect to a bottom cover 108. The hinge 104 includes a first end 110, and a second end 111 both affixed to the bottom cover 108, and a middle portion 112 affixed to the top cover 106. The middle portion 112 includes a sub-hinge 114, which permits the top cover 106 to rotate about a second axis (B) 115 with respect to the bottom cover 108. Those skilled in the art recognize that there are an unlimited number of orientations of the top cover 106 with respect to the bottom cover 108 about the hinge 104 and sub-hinge 114.

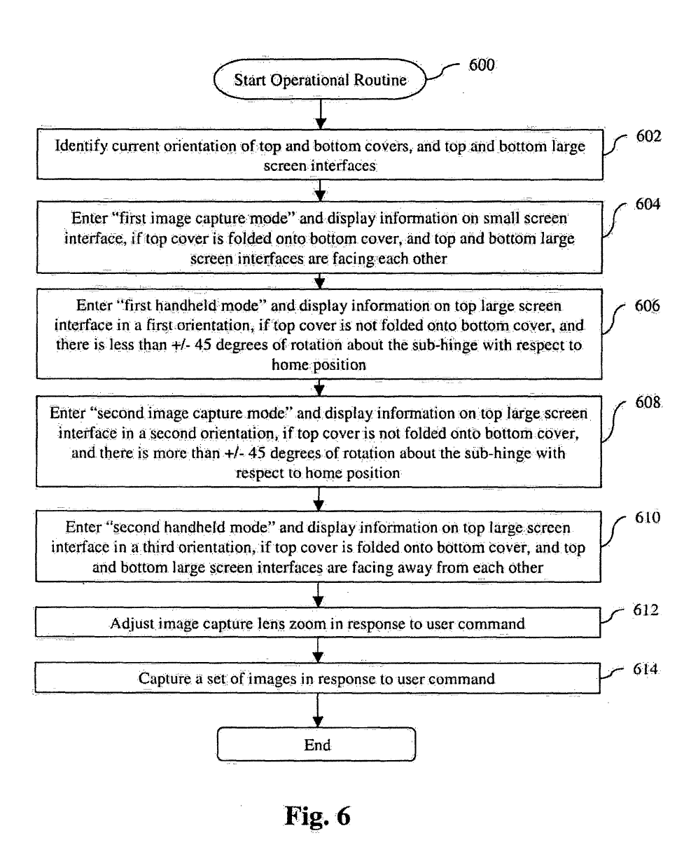

Rotation of the top and bottom covers 106 and 108 with respect to each other automatically determines a mode in which the device 102 operates. These modes include: a “first image capture mode,” a “first handheld mode,” a “second image capture mode,” and a “second handheld mode.” A preferred method for determining when each mode is entered and what effect each mode has on the device 102, is described below with respect to FIG. 6. Those skilled in the art however recognize that while the modes describe are preferred, they can be varied for different implementations of the present invention.

The hinge 104 also includes an image capture device 116 located within the first end 110 and a small screen interface 118 located within the second end 111 of the hinge 104. The image capture device 116 includes a light sensitive sensor for acquiring optical information, and one or more lenses for focusing optical light on the light sensitive device. Some embodiments of the image capture device 116 include multiple lens which can translate with respect to each other, so as to provide an optical zoom capability. Additional lenses and/or filters (not shown) may also be attached to the image capture device 116 to provide for enhanced image capture capabilities. The small screen interface 118 is preferably capable of displaying both captured images (either in real-time like a viewfinder or which have been previously recorded) and any other information generated by the device 102. Both the image capture device 116 and the small screen interface 118 are preferably aligned along the hinge's axis of rotation so that users may simultaneously capture and view images when the top and bottom covers 106 and 108 of the device 102 are closed.

The bottom cover 108 includes a telephoto (T) and wide-angle (W) zoom control 120 beneath the small screen interface 118 and a shutter control 122 beneath the image capture device 116. The zoom control 120 provides for an optical and/or digital zoom feature, and the shutter control 122 instructs the device 102 to capture one or more images (i.e. a still picture or a video clip) using the image capture device 116. The bottom cover 108 also includes a bottom large screen interface 124 and a touch sensitive pad 126. The bottom large screen interface 124 is at a minimum preferably capable of receiving input commands from users of the device 102, but may also display any information generated by the device 102, including captured images. The bottom large screen interface 124 preferably accepts a pen inputs, while user selections are made with the touch sensitive pad 126. In alternate embodiments, the bottom large screen interface 124 may be wholly replaced with another input device, such as a keyboard or touch sensitive pad.

The top cover 106 includes a top large screen interface 128 and a set of selection buttons 130. The top large screen interface 128 preferably functions as an image display for either captured images or other information generated by the device 102. However, since the top cover 106 can be rotated and flipped back onto the bottom cover 108 such that the top large screen interface 128 faces away from the bottom large screen interface 124, the top large screen interface 128 preferably can also accept user inputs so that the device functions as a tablet computer.

Other features of the device 102 include: a sound capturing device, so that sounds may be recorded by the device 102 along with images; a biometric fingerprint recognition pad 132 for unlocking the device 102; wireless phone and networking capabilities; and spatial locational device.

FIG. 6 is a flowchart 600 of one embodiment of a method of operation for the device. The method begins in step 602 where the device 102 identifies a current orientation of top and bottom covers 106 and 108, and top and bottom large screen interfaces 128 and 124.

Next in step 604, the device 102 enters a “first image capture mode” and displays information on the small screen interface 118, if the top cover 106 is folded onto bottom cover 108, and top and bottom large screen interfaces 128 and 124 are facing each other. FIGS. 1, 3 and 4 show the device in the “first image capture mode.” In this mode, users are capturing images with the image capture device 116 while looking through the small screen interface 118 at what is being captured. Users may prefer this mode out of convenience or due to bright lighting conditions which would otherwise obscure images displayed on one of the large screen interfaces 124 and 128.

In step 606, the device 102 enters a “first handheld mode” and displays information on the top large screen interface 128 in a first (preferably portrait) orientation, if the top cover 106 is not folded onto the bottom cover 108, and there is less than +/−45 degrees of rotation about the sub-hinge 114 with respect to home position. The home position is herein preferably defined as the orientation of the top and bottom covers 106 and 108 about the sub-hinge 114 as shown in FIG. 2. FIG. 2 shows the device in the “first handheld mode.” In this mode, users are primarily using the device 102 as a handheld PDA, whereby commands and inputs are received on the bottom large screen interface 124 and information is displayed on the top large screen interface 128.

In step 608, the device 102 enters a “second image capture mode” and displays information on the top large screen interface 128 in a second (preferably landscape) orientation, if top cover 106 is not folded onto bottom cover 108, and there is more than +/−45 degrees of rotation about the sub-hinge 114 with respect to the home position. FIG. 5 shows the device in the “second image capture mode” after the top cover 106 as been rotated approximately 90 degrees about the sub-hinge 114. In this mode, users are capturing images with the image capture device 116 while looking through the top large screen interface 128 at what is being captured. Users may prefer this mode when viewing images on the top large screen interface 128 would be more convenient than viewing them on the small screen interface 118.

Then in step 610, the device 102 enters a “second handheld mode” and displays information on the top large screen interface 128 in a third (preferably portrait) orientation, if top cover 106 is folded onto the bottom cover 108, and the top and bottom large screen interfaces 128 and 124 are facing away from each other. The third orientation is upside-down with respect to the first orientation. This mode is not shown in the Figures, however, in this mode, users are primarily using the device 102 as a handheld tablet computer, whereby commands and inputs are received and information is displayed on the top large screen interface 128.

Those skilled in the art will know that the values given for degrees of rotation, home position, image orientation, and information displayed and/or received on the screen interfaces, as discussed herein are preferred but not required. Other embodiments of the present invention may vary these elements to fit any particular design. Such other embodiments can perhaps include replacing the “second handheld mode” in step 610 with a “simultaneous handheld and image capture mode” which displays information on both the top large screen interface 128 and the small screen interface 118, when the top cover 106 is folded onto the bottom cover 108, and the top and bottom large screen interfaces 128 and 124 are facing away from each other.

Next in step 612, the device 102 adjusts zoom of the image capture lens 116 in response to user command (e.g. rocking the zoom control 120). And in step 614, the device 102 captures a set of image in response to user command (e.g. pressing the shutter button 122).

While one or more embodiments of the present invention have been described, those skilled in the art will recognize that various modifications may be made. Variations upon and modifications to these embodiments are provided by the present invention, which is limited only by the following claims.

1. A handheld device, comprising:
a top portion;
a bottom portion;
a hinge, rotational about a first axis and having a first end and a second end, coupling the top portion to the bottom portion; and
an image capture device, coupled to the first end of the hinge and oriented to capture images aligned along the first axis of the hinge.

2. The device of claim 1, wherein:
wherein the handheld device is a personal digital assistant.

3. The device of claim 1, wherein:
wherein the handheld device is a cell phone.

4. The device of claim 1, wherein:
wherein the handheld device is a laptop computer.

5. The device of claim 1, wherein the image capture device includes:
an optically adjustable lens.

6. The device of claim 1, further comprising:
a lens filter coupled to the image capture device along the first axis.

7. The device of claim 1, further comprising:
a detachable lens coupled to the image capture device along the first axis.

8. The device of claim 1, further comprising:
a shutter control coupled to the image capture device.

9. The device of claim 1, further comprising:
a sub-hinge coupling the top portion to the bottom portion, and rotational about a second axis which is perpendicular to the first axis.

10. The device of claim 1, further comprising:
a small screen interface, coupled to the second end and aligned along the first axis of the hinge, for displaying images captured by the image capture device.

11. The device of claim 1, wherein the top portion includes:
a large screen interface for displaying images captured by the image capture device and other handheld device information.

12. The device of claim 11, wherein the bottom portion includes:
a second large screen interface for accepting input for controlling the handheld device.

13. A personal digital assistant, comprising:
a top portion;
a bottom portion;
a hinge, rotational about a first axis and having a first end and a second end, coupling the top portion to the bottom portion;
an image capture device, coupled to the first end of the hinge and oriented to capture images aligned along the first axis of the hinge;
a sub-hinge coupling the top portion to the bottom portion, and rotational about a second axis which is perpendicular to the first axis;
a small screen interface, coupled to the second end and aligned along the first axis of the hinge, for displaying images captured by the image capture device;
a first large screen interface for displaying images captured by the image capture device and other digital assistant information; and
a second large screen interface for accepting input for controlling the digital assistant.

14. A method for operating a handheld device, comprising:
permitting a first large screen interface to rotate about a first hinge axis with respect to a second large screen interface;
capturing images aligned along the first hinge axis; and
setting a mode in which the device operates in response to an orientation of the first large screen interface to a second large screen interface.

15. The method of claim 14 wherein the setting element includes:
displaying information on a small screen interface aligned along the first hinge axis, if the first large screen interface is folded onto the second large screen interface, and the top and bottom large screen interfaces are facing each other.

16. The method of claim 14 wherein the setting element includes:
displaying information on the first large screen interface in a first portrait orientation, if the first large screen interface is not folded onto the second large screen interface, and there is less than +/−45 degrees of rotation about a second hinge axis, which is perpendicular to the first hinge axis.

17. The method of claim 14 wherein the setting element includes:
displaying information on the first large screen interface in a landscape orientation, if the first large screen interface is not folded onto the second large screen interface, and there is more than +/−45 degrees of rotation about a second hinge axis, which is perpendicular to the first hinge axis.

18. The method of claim 16 wherein the setting element includes:
displaying information on the first large screen interface in a second portrait orientation, if the first large screen interface is folded onto the second large screen interface, and the first and second large screen interfaces are facing away from each other, wherein the second portrait orientation is upside-down with respect to the first portrait orientation.

19. The method of claim 14 wherein the setting element includes:
displaying information on both a small screen interface and a large screen interface, if the first large screen interface is folded onto the second large screen interface and the first and second large screen interfaces are facing away from each other.

20. A handheld device, comprising a:
means for permitting a first large screen interface to rotate about a first hinge axis with respect to a second large screen interface;
means for capturing images aligned along the first hinge axis; and
means for setting a mode in which the device operates in response to an orientation of the first large screen interface to a second large screen interface.
